(19) United States
(12) Patent Application Publication
(10) Pub. No.: US 2026/0356123 A1
(43) Pub. Date: Nov. 12, 2026

(54) VEHICLE COMPRISING AN IMPROVED BALLAST SYSTEM

(71) Applicant: CNH Industrial Italia S.p.A., Turin (IT)

(72) Inventors: NICOLA DI STASI, Modena (IT); LUISA NACLERIO, Modena (IT)

(73) Assignee: CNH Industrial Italia S.p.A., Turin (IT)

(21) Appl. No.: 19/668,201

(22) Filed: May 5, 2026

(30) Foreign Application Priority Data
May 8, 2025 (IT) 102025000010377

(51) Int. Cl. B60B 15/28

(52) U.S. Cl. CPC B60B 15/28

(57) ABSTRACT

Provided is a ballast system for an off-road vehicle including a first portion configured to be mechanically coupled to a hub of the off-road vehicle and a second portion comprising at least one ballast element configured to define a pre-set weight. The second portion being configured to be mechanically coupled to the first portion.

### TECHNICAL FIELD

The present invention relates to a ballast system for a work vehicle.

The present invention has a preferred, though not exclusive, application in the field of work vehicles, for example agricultural tractors, earth moving machines, off-road vehicles. Reference to this application will be made below by way of example.

### BACKGROUND OF THE INVENTION

Work vehicles such as agricultural vehicles, i.e. tractors, are provided with ballasts, e.g. carried by wheels, to provide additional load to maintain stable the vehicle during work operation.

In particular, wheel’s ballasts are assembled on the wheels before assembling the wheels on the tractor.

Such ballasts are directly assembled by bolting to the wheel’s rim. In fact, the most used tractors comprise wheels whose rims are provided with holes designed to accommodate ballast fixing bolts.

In detail, such ballast assembled to wheel’s rim, although robust and safe, requires the use of specific tools that increase complexity in assembling and disassembling the ballast, thereby increasing installation costs.

Furthermore, assembling or disassembling the ballasts on the tractor wheels increases the risk of damage to the tractor or ballasts themselves.

Moreover, such ballast system makes long and difficult the removal of ballast because it is needed to remove the wheel in order to assemble and disassemble the ballast, thereby limiting the operational flexibility of the tractor.

For example, if it is needed to quickly switch from an activity that requires ballasts to one that does not, the difficulty of removal can slow down the process compromising overall efficiency.

Furthermore, assembling or disassembling the ballast by removing the wheels from the tractor can cause various problems of instability of the tractor or even accidents.

Furthermore, the repeated assembly and disassembly of ballasts and wheels linked to the installation/removal of other tractor components can wear the latter such as bolts, pins and other fastening systems. Indeed, said wear can lead to safety problems or require expensive repairs.

Therefore, there is a need to improve the ballast system for work vehicles reducing complexity, their costs and improving their safety, thereby providing a viable alternative to conventional known systems.

The aim of the present invention is to overcome the aforementioned drawbacks, in an optimised and economical manner.

### SUMMARY OF THE INVENTION

The above purpose is achieved by a ballast system as claimed in the attached claims forming an integral part of this description.

### BRIEF DESCRIPTION OF DRAWINGS

For a better understanding of the present invention, a preferred embodiment is described in the following, by way of a non-limiting example, with reference to the attached drawings wherein:

FIG. 1 is a perspective view of a work vehicle comprising a ballast system according to the invention, with parts removed for clarity;

FIG. 2 is a perspective view of a portion of the work vehicle of FIG. 1, with parts removed for clarity;

FIG. 3 is a plan view of an element of the ballast system with parts removed for clarity;

FIG. 4 is a diametrical sectional view, schematic and with parts removed for clarity, illustrating the element of FIG. 3;

FIGS. 5 and 6 are respectively a sectioned view and an exploded perspective view of a first embodiment of a ballast system, with parts removed for clarity;

FIGS. 7 and 8 are respectively a sectioned view and an exploded perspective view of a second embodiment of a ballast system, with parts removed for clarity;

FIGS. 9 and 10 are respectively a sectioned view and an exploded perspective view of a third embodiment of a ballast system, with parts removed for clarity;

FIG. 11 is a perspective view of the embodiments of FIGS. 5-10, with parts removed for clarity; and

FIG. 12 is a sectioned view of a ballast system according to an embodiment of the present invention.

### DETAILED DESCRIPTION OF THE INVENTION

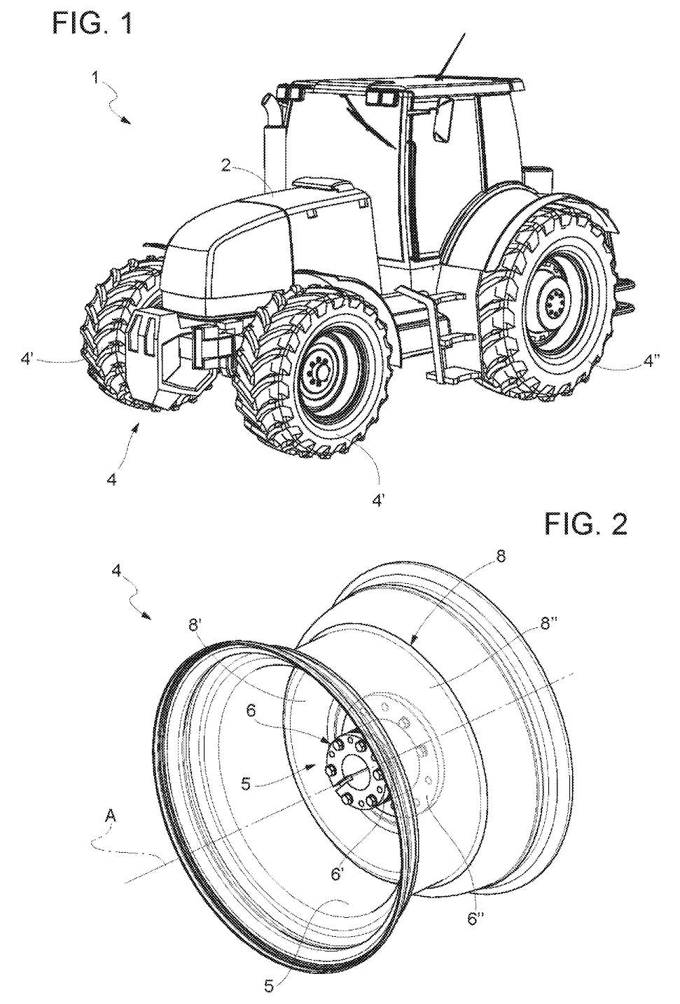

In FIG. 1 is indicated overall with reference number 1 a work vehicle, such as an agricultural tractor.

Tractor 1, as known, comprises a body 2 carried movable on ground via ground engaging means 3, in the disclosed embodiment by wheels 4. In particular, the vehicle 1 of the shown embodiment comprises a pair of front wheels 4' and a pair of rear wheels 4''.

In detail, the wheels 4 are carried by vehicle body 2, e.g. by a related axle of a suspension system.

As known, tractor 1 comprises a hub 5 that is carried in rotation by a transmitting motion system (not illustrated) for transmitting its motion to the ground engaging means 3, i.e. to wheel 4.

In particular, hub 5 comprises a tubular element 6 comprising an axial wall 6’ and a radial wall 6’’.

In detail, axial wall 6’ is axisymmetric with respect to axis A and therefore defining a substantially cylindrical shape.

In further detail, radial wall 6’’ extends radially starting from the axial wall 6’, in particular at an axial extremity thereof.

Advantageously, radial wall 6’’ comprises holes 7 configured to house connecting means 7’, such as threaded elements, configured to keep axially packed the hub 5 and the wheel 4 so that they are integral with the transmitting motion system (not shown) of the tractor 1.

In particular, the wheel 4 comprises a rim 8 of known typology. Accordingly, the rim 8 comprises a disk portion 8’ configured to allow coupling to hub 5 and an axial portion 8’’ configured to allow support for a tire, not shown.

The rim 8 therefore delimits a portion of space S that is axially delimited from one side by the disk portion 8’ and opened to the environment to the other side and radially delimited by the axial portion 8’’ with respect to axis A.

Tractor 1 comprises a ballast system 9 configured to be selectively fixed connected to hub 5 to provide an additional load thereto.

In detail, ballast system 9 is configured to be fixed to the radial wall 6’’ of the hub 5 as disclosed below.

The ballast system 9 comprises a first portion 10' and a second portion 10''.

In particular, the first portion 10' comprises one or more support elements 11 and is configured to be mechanically coupled to the hub 5; the second portion 10'' comprises one or more ballast elements 12 and is configured to be mechanically coupled to the first portion 10'.

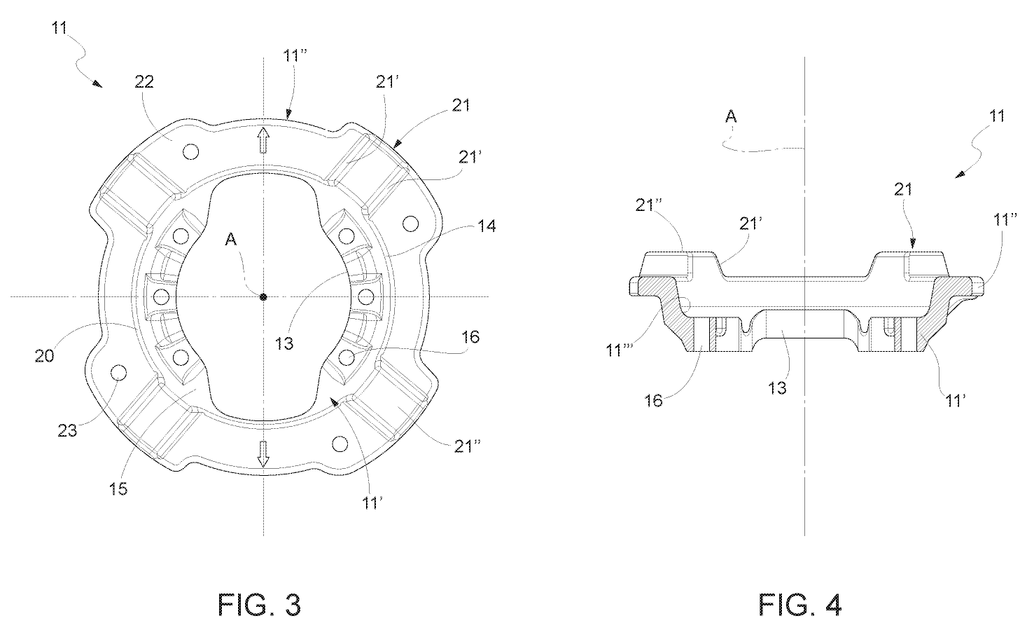

As illustrated in FIGS. 3 and 4, the support element 11 comprises a first and a second coupling portions 11', 11'' wherein the first coupling portion 11’ is configured to be fixed to hub 5 and the second coupling portion 11’’ is configured to be connected to the second portion 10’’.

Preferably, the first and the second coupling portions 11’, 11’’ have a substantial circular shape, i.e. they are disk shaped.

In detail, the first coupling portion 11' has a radial extension about axis A that is smaller than the second coupling portion 11’’, i.e. the diameter of the first coupling portion 11’ is smaller than the diameter of the second coupling portion 11''.

In particular, the support element 11 comprises a connecting portion 11’’’ connecting together the first and second coupling portion 11’, 11’’.

In detail, the connecting portion 11’’’ has variable shape configured to connect together at least a minimum diameter portion of the second coupling portion 11’’ to a maximum diameter portion of the first coupling portion 11’.

The first coupling portion 11’ is preferably annular, i.e. defines a first opening 13 configured to house, at least partially, the hub 5, i.e. the axial portion thereof.

Similarly, the second coupling portion 11’’ is annular and defines a second opening 14 that has a diameter that is greater than the diameter of the first opening 13.

Preferably, first and second openings 13, 14 are coaxial to axis A, such as preferably the first and second coupling portions 11’, 11’’ are coaxial between themselves.

Owing to the above, support element 11 defines a first axial surface 15 due to the difference of diameter of the first and second openings 13, 14.

In use, the first axial surface 15 is placed on the opposite side with respect to the hub 5 of the first coupling portion 11’.

In particular, the first and second coupling portions 11', 11'' and the connecting portion 11’’’ are made of a single piece.

In the disclosed embodiment, the first coupling portion 11’ defines a plurality of first openings 16, in particular realized as through holes, configured to allow housing of connecting means 7’, such as threaded elements, to allow connection to the hub 5, as stated above.

The first openings 16 are circumferentially spaced one with respect to the other and, preferably, are each equal to the other.

In the disclosed exemplary embodiment, the first openings 16 are grouped in two separate groups placed diametrically opposite one to the other.

In detail, each group comprises three first openings 16 wherein each opening of each of the above-mentioned group is preferably equally spaced to the other.

In use, the first openings 16 are coaxial to the respective holes 7 realized in the radial wall 6’’ and not further described for sake of brevity.

The second coupling portion 11'' of the support element 11 defines a second axial surface 20 substantially parallel with respect to the first axial surface 15 of the first coupling portion 11’, i.e. offset according to the position of the second coupling portion 11’’ with respect to the first coupling portion 11’ along axis A.

In particular, the second coupling portion 11’’ comprises a plurality of protuberances 21 which extend axially from the second coupling portion 11’’, in particular starting from the second axial surface 20.

In other words, protuberances 21 extend axially on the opposite side with respect to the first coupling portion 11’ and are preferably spaced one to the other circumferentially about axis A and in further detail they are equally spaced.

Preferably, they are in number of at least three and disposed in a pair opposite manner.

Preferably, each protuberance 21 extends from a flanged portion 22 of the second coupling portion 11’’ that extends radially with respect to axis A with respect to the remaining portion.

In particular, ballast system 9 comprises centering means 24 configured to center about axis A the second portion 10’’ with respect to the first portion 10’.

In detail, centering means 24 may comprise at least one of the protuberances 21 described above.

Accordingly, flanged portions 22 are preferably spaced one to the other circumferentially about axis A and in further detail they are equally spaced, therefore in correspondence of the protuberances 21.As illustrated in FIG. 4, each protuberance 21 comprises two side walls 21' and a top wall 21'' configured to define together with the flanged portion 22 a base of a substantially quadrangular shape, such as a trapezoid.

In particular, these side walls 21' extend with respect to the second axial surface 20 along axis A of each protuberance 21, are positioned facing each other and spaced circumferentially.

In detail, the side walls 21' can be inclined with respect to axis A by a respective angle.

The top wall 21'' is arranged between the two side walls 21' and therefore extends radially and circumferentially about axis A.

In particular, the second coupling portion 11’’ comprises second openings 23 configured to couple the support element 11 to the second portion 10’’.

In particular, such second openings 23 are through holes and preferably are realized, as shown, in the flanged portion 22.

In detail, second openings 23 are circumferentially spaced one with respect to the other and, preferably, are each equal to the other.

Preferably, they are in number of at least four and disposed in a pair opposite manner, and in further detail adjacent to the protuberances 22.

Returning to ballast element 12, it is configured to be mechanically coupled to the first portion 10’, in particular to the support element 11 as stated above.

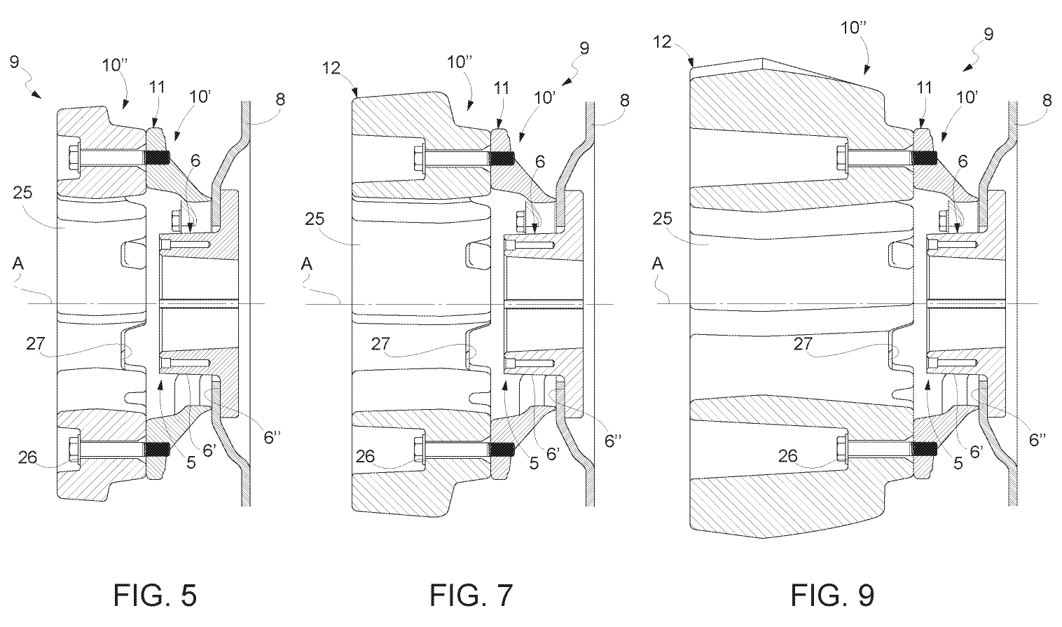

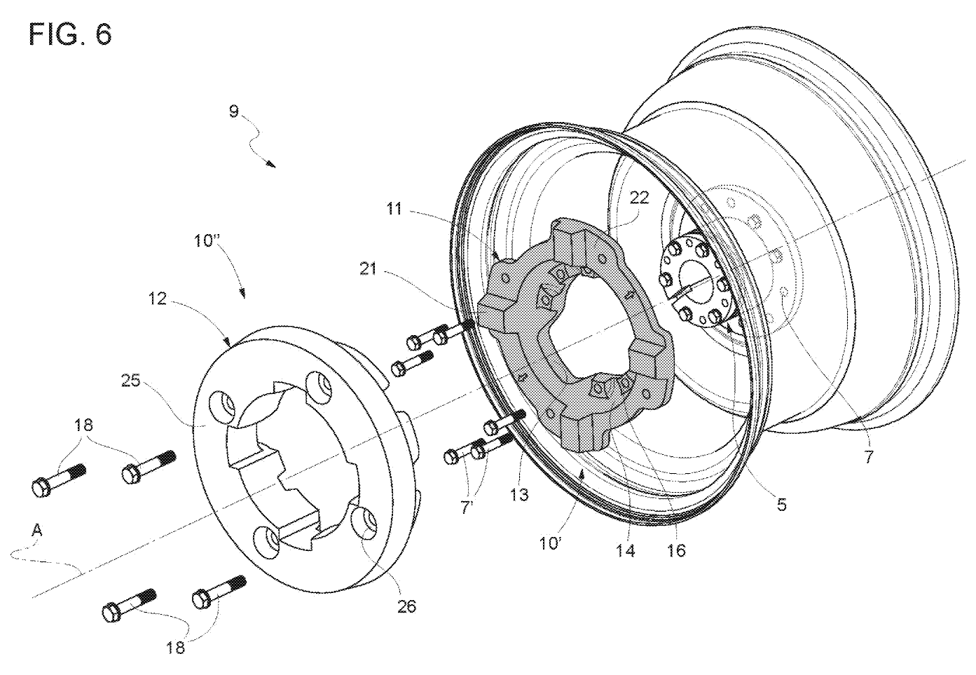

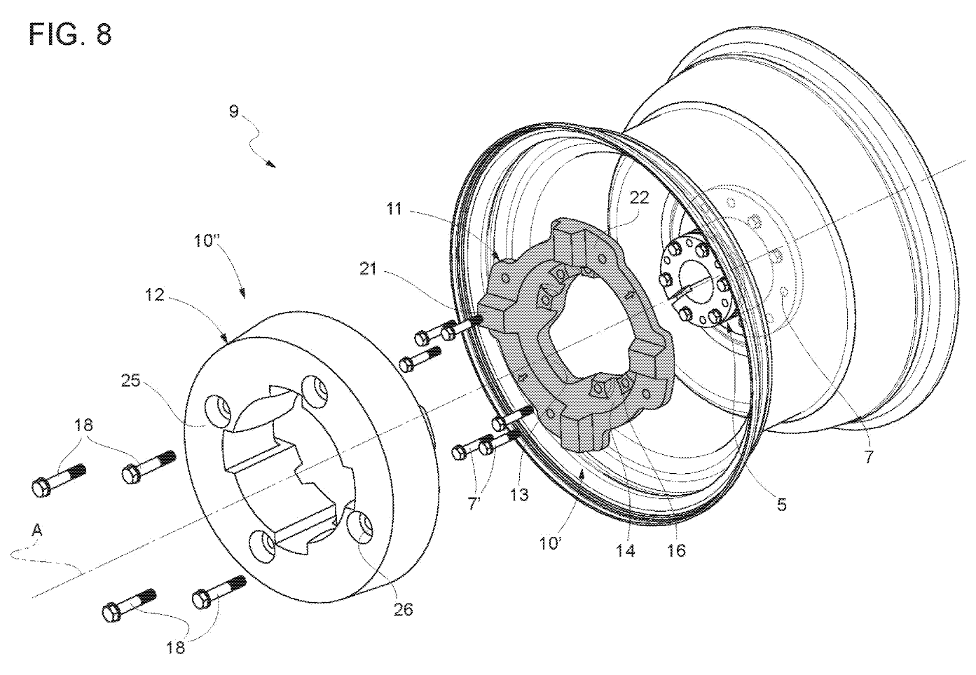

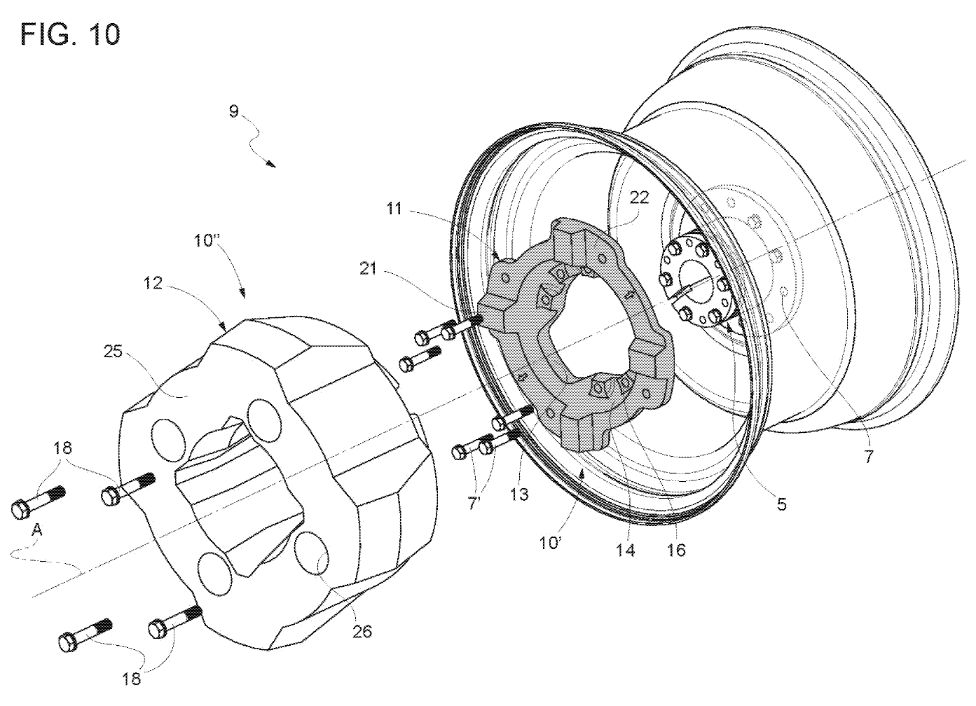

In detail, the ballast element 12 comprises a body 25 that extends along axis A and has a variable shape as illustrated in FIGS. 5-11.

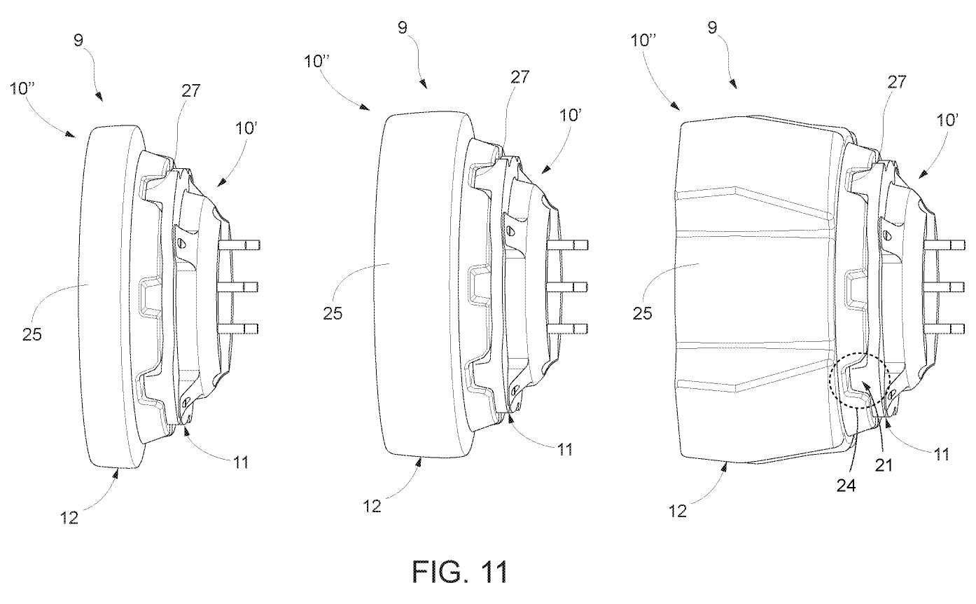

In detail, the ballast element 12 shape and material are designed to provide a specific additional load. In FIG. 11 three different possible designs are shown corresponding to different weights associated with the body 25. Further details about the geometry of the body are not provided, being not pertinent to the present invention.

In particular, body 25 of the ballast element 12 further comprises a plurality of third openings 26, in particular through holes, configured to allow housing of further connecting means 18, such as threaded elements, to allow connection to the support element 11, as stated above.

In use, the third openings 26 are coaxial to the second openings 23 realized in the support element 11 and not further described for sake of brevity.

In particular, the body 25 comprises a plurality of seats 27 of which at least some are configured to house, in use, a respective protuberance 21 of the support element 11.

Accordingly, the seats 27 extend axially within the body 25 in particular starting from an external surface thereof.

Preferably, they are equally spaced circumferentially along axis A. In further detail, they can be in the same number or in a greater one with respect to the protuberances 21.

At least in the case in which they are the same number, one of the seats 27 have a dimension that is greater, radially and/or circumferentially with respect to axis A, with respect to the protuberance 21, thereby defining a clearance that allows the passage of a oblong element such as wire/cable/pipe/hose 30 as described below in detail.

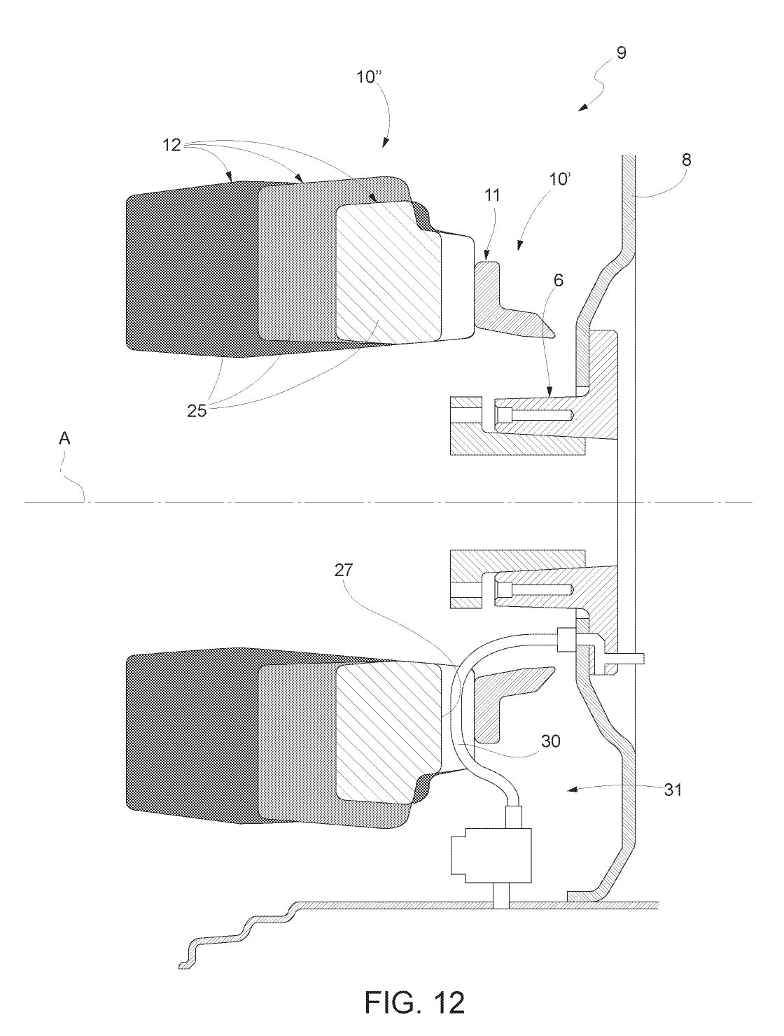

As better shown in FIG. 12, vehicle 1 may comprise assistance driving systems 31 such as CTIS, i.e. central tire inflation system, of known typology and not further described.

Such assistance driving systems 31 are connected to respective control unit (not shown) by the oblong element 30 as mentioned above.

The difference of dimension between the seat 27/protuberance 21 or the additional seat allow the passage of such wire/cables 30.

The operation of the ballast system 12 described above according to the invention is as follows.

In order to fix the ballast system 12 on the wheel 4, which is already fixed on the hub 5, the operator prepares the support element 11, the ballast element 12 and the connecting means 18.

In particular, the operator fixes the support element 11 to the radial wall 6’’ of the hub 5 by tightening the connecting means 7’ inside the holes 7 of the radial wall 6’’ and the first through holes 16 of the support element 11.

Once these have been fixed, the operator can place the ballast element 12 on the support element 11 by engaging the centering means 24, such as protuberances 21.

As shown in the embodiments of FIGS. 5-11, protuberances 21 of the support element 11 are engaged in the hollow seats 27 of the ballast element 12.

In this way, the first through holes 16 of the support element 11 are coaxial with the third openings 26 of the ballast element 12 so as to be able to proceed with tightening the connecting means 18 inside the aforementioned first and third openings 16, 26.

In case there is the need to allow the passage of the oblong element30 out of the rim 8, the user may place such oblong element30 within the free seats 27 or within the larger seat 27 thereby allowing its safe passage before fixing the body 25 to the support element 11.

In view of the foregoing, the advantages of a ballast system according to the invention are evident.

Thanks to ballast system 9 it is possible to secure a ballast 12 to a wheel 4 in a tractor 1 in a quick, safe and easy manner.

Advantageously, ballast system 9 allows to install or replace the ballast elements 12 without the need to intervene significantly on the dismount of the tractor components, in particular the wheel 4.

Indeed, support element 11 can always be secured to the wheel 4 and only the body 25 can be exchanged when necessary.

Moreover, the centering between the support element 11 and the ballast element 12 is achieved by centering means 24 provided between these latter.

Furthermore, the engagement between the centering means 24 and the ballast element 12 facilitates the definition of the correct orientation angle between the support element 11 and the ballast element 12.

In addition, the ballast system 9 has dimensions consistent with the structure of the tractor 1 without having an impact from a construction and design point of view.

In particular, due to the versatility of the proposed ballast system 9 it is possible to use this latter as a kit in different vehicle typology.

Finally, it is clear that modifications and variations can be made to the ballast system 9 according to the present invention which does not extend beyond the scope of protection defined by the claims.

For example, it is clear that the shape of the support element 11 or that of the ballast elements 12 can be different, as illustrated in FIGS. 5-11.

As already mentioned, hub 5 and radial wall 6’’ could be made in two separate elements and not in one piece as above described.

Furthermore, the connecting means 24 described could be replaced by equivalent means.

In particular, it is clear that described holes can vary their number or their shape or disposition within the scope claimed below.

In detail, the protuberances 21 described as part of the support element 11 can be provided on the body 25 and the openings 16 on the support element 11, i.e. a dual version with respect to the described one or a mix of these latter.

Clearly, it is possible that further additional mechanical elements such as seals, screws or other elements that are necessary and obvious from a construction point of view could be present and not further described for brevity.

1. A ballast system for an off-road vehicle, the ballast system comprising:
a first portion configured to be mechanically coupled to a hub of the off-road vehicle; and
a second portion comprising at least one ballast element configured to define a pre-set weight, wherein the second portion is configured to be mechanically coupled to the first portion.

2. The ballast system according to claim 1, wherein:
the first portion comprises at least one support element,
the support element comprises a first coupling portion and a second coupling portion,
the first coupling portion is configured to be fixed to the hub, and
the second coupling portion is configured to be connected to the second portion.

3. The ballast system according to claim 2, wherein the first and second coupling portions have a circular shape.

4. The ballast system according to claim 3, wherein the first and second coupling portions have an annular shape so as to be housed about the hub.

5. The ballast system according to claim 4, wherein:
the support element comprises a connecting portion configured to connect the first and second coupling portions, and
the first and second coupling portions and the connecting portion are realized as one piece.

6. The ballast system according to claim 5, wherein each coupling portion between the first and second coupling portions defines a first opening and a second opening configured to allow passage of a connector to allow connection to respective elements.

7. The ballast system according to claim 6, further comprising a centering configured to center the second portion with respect to the first portion.

8. The ballast system according to claim 7, wherein:
the centering comprises at least one protuberance carried by one between the support element and the ballast element, and
the centering is configured to be housed within a respective seat of a plurality of seats realized in the other between the support element and the ballast element.

9. The ballast system according to claim 8, wherein:
the protuberance is carried by the support element, and
the respective seat is realized in the ballast element.

10. The ballast system according to claim 9, wherein at least one seat among the plurality of seats is shaped so as to house a respective protuberance with a gap, the gap being designed to allow the passage of an oblong element of the off-road vehicle.

11. The ballast system according to claim 10, wherein the centering comprises more seats with respect to the number of protuberances, wherein one seat among the plurality of seats is unoccupied by a protuberance being configured to house the oblong element of the off-road vehicle.

12. A wheel assembly for an off-road vehicle comprising:
a hub; and
a rim carried by the hub and a ballast system, wherein the ballast system includes:
a first portion configured to be mechanically coupled to a hub of the off-road vehicle; and
a second portion comprising at least one ballast element configured to define a pre-set weight, wherein the second portion is configured to be mechanically coupled to the first portion.

13. The wheel assembly according to claim 12, wherein the wheel assembly is included in the off-road vehicle, and the off-road vehicle is a work vehicle.

14. A vehicle comprising:
a hub; and
a ballast system coupled to the hub, the ballast system including:
a first portion configured to be mechanically coupled to a hub of the vehicle; and
a second portion comprising at least one ballast element configured to define a pre-set weight, wherein the second portion is configured to be mechanically coupled to the first portion.

15. The wheel assembly of claim 14, wherein the wheel assembly is included in the vehicle, and the vehicle is a work vehicle.

16. The ballast system according to claim 10, further comprising an assistance driving system including an oblong element passing through one seat among the plurality of seats.

17. The ballast system according to claim 11, further comprising an assistance driving system including an oblong element passing through one seat among the plurality of seats.
